(19) United States
(12) Patent Application Publication
(10) Pub. No.: US 2021/0120800 A1
(43) Pub. Date: Apr. 29, 2021

(54) Equine Ice Removal Tool

(71) Applicants: Tammy Wenzel, Marshfield, WI (US); Erlan Wenzel, Marshfield, WI (US)

(72) Inventors: Tammy Wenzel, Marshfield, WI (US); Erlan Wenzel, Marshfield, WI (US)

(21) Appl. No.: 16/664,405

(22) Filed: Oct. 25, 2019

(51) Int. Cl. A01L 11/00; A01L 15/00

(52) U.S. Cl. CPC A01L 11/00; A01L 15/00

(57) ABSTRACT

A hand tool directed to the practice of the efficient removal of snow, ice, and debris buildup from a horse's hoof is provided. The hand tool includes an elongated handle with a t-section tool head comprised of a first striking surface at one end to effectuate removal of ice buildup and a second striking surface with a beveled edge at the opposing end of the tool head, to assist in the scooping removal of debris built up. On an opposing section of the elongated handle located away from that of the tool head is provided a hoof pick to assist in the precision removal of small debris particles.

### FIELD

The present invention is directed to the field of a hand tool, and more particularly, by describing in no way to be read as a form of limitation, to a hand tool for the purpose of animal care, and specifically directed to the field of equine care.

### INTRODUCTION

There is some debate among historians as to the date of the first use of a horse as an animal in which humans were able to work, train, and breed. While exact dating is not possible, it is agreed that domesticated horses have been around the world for at least the past few thousand years. Since domestication, humans have used horses for a variety of different tasks, such as pulling loads or as a vessel for a human to ride upon.

As a horse is a living organism that moves by walking it is important that their feet, known singularly as a hoof and in the plural as hooves, are well cared for. In more northern climates, such as continental and polar climates, the winter seasons can be quite cold. In these colder climates, it is common to have ice buildups in various areas such as inside a horse's hoof or hooves. Horse hooves generally have a concave interior in or near the center of the hoof, which is where ice might buildup.

The ice tends to form at times in a horse's hoof in a convex rounded shape, which amounts to a horse walking on the edge of an ice ball. These ice balls may cause multiple problematic issues as the affected horse is now walking on the solid ice buildup which may lead to strains, sprains, bruises, hoof cracks, as well as slips and falls.

To prevent the injuries above-mentioned, farriers and horse owners alike will presently employ various differing methods after an ice ball has built up so as to remove the ice ball obstruction. A common method in use is to use a bucket of warm water to soak a hoof in. However, the time spent waiting for the ice to melt away can become exhaustive and a horse is then standing at an uneasy position on the other hooves, particularly if these other hooves have ice balls built up inside them as well.

Another common method is to utilize a hoof pick to remove the buildup of ice therein. A hoof pick is typically shaped similar to an “L” and has a long narrow tool generally used to clean dirt and debris out of a hoof. However a hoof pick is more of a precision tool as it has a small striking surface. When it is used to try and get ice buildup out of a hoof, the small striking surface of the narrow hoof pick can result in a cumbersome process of using a precision tool to remove a large obstruction which results in the horse standing on its other three hooves, similar to the issues of the warm water bucket solution as just described.

To expedite the process, there are some who will use a blunt instrument such as a hammer or a chisel. However, in the interior of a horse hoof is a mass of tissue known as the frog. The frog of a horse's hoof is not only sensitive, but serves important functions, and damage to this frog area from any means, to include brute force when attempting to remove debris, can cause health injuries to the horse, and prevent the horse from applying the proper use of said hoof itself.

Accordingly, it is imperative that accuracy and precision are a paramount concern when attempting to remove the ice ball buildup. What is needed, therefore, is a device which is able to safely, quickly, and efficiently eliminate ice balls which are accumulated in a horse's hoof, so as to allow the horse to safely maneuver while walking.

### SUMMARY OF THE INVENTION

The present disclosure is directed to an ice removal tool which is useful for cleaning the interior and exterior portions of an equine's hoof, among other uses. It is important at this time to note that although some of the multiple embodiments and variations of the present disclosure are laid out herein, it is to be appreciated that there are numerous alternative variations of these disclosed embodiments and variations that would be obvious to one of skill in the art, and the specific embodiments discussed throughout are merely illustrative of some of the ways to make and use this invention and are not in any way to be interpreted or held to be limited as to the scope of the present invention.

A preferred embodiment of the present disclosure will have a handle which is preferably balanced and preferably designed specifically to be used and manipulated by a human user's hand. This handle is an elongated handle, presently thought of to be generally cylindrical in manner, but alternative elongated shapes such as rectangular prisms or even conical shapes are contemplated herein. As a result of its shape, the elongated handle has a first end and a second end, otherwise known as a top and a bottom end, depending on the particularities.

In an alternative embodiment the elongated shaped handle may additionally be received by an ergonomic handle around the circumference, or the exterior of the handle thereof. This ergonomic handle may be a useful addition, as its presence can help to reduce fatigue, injury, and the possibility of slipping out of a user's hand.

A substantially linear central body is attached, formed, affixed, or otherwise integral with the first end of the elongated handle. In such a fashion, the resulting formation is similar to a “T”, and the substantially linear central body thus has two distal ends, being the top portion of said “T” shape. The closest portions of the substantially linear central body relative to the elongated handle first end are known as connection points. On the top portion of the substantially linear central body at the two distal ends respectively are a first strike surface and a second strike surface. The first strike surface may contain additional instruments to aid in the removal of ice and debris such as a chisel, a hammer, a flat-edge, a hoof pick, a hoof knife, a scoop, or any other similar hand tool, and the second strike surface additionally contains an instrument such as those just-mentioned. In such a fashion, an instrument is located at the two respective distal ends of the substantially linear central body. An instrument is also provided at the second end, or bottom end, of the elongated handle. Thus a preferred embodiment may contain three such instruments.

The two strike surfaces and the substantially linear central body are collectively known as the tool head of the present disclosure. The tool head extends perpendicular to the longitudinal axis of the elongated handle, but in one alternative embodiment additionally features hinges, bearings, or bores in order to provide for 90-degree rotation, as is made clear in the appended figures. This angle is thought to be from the hinge connection point, used as the vertex, where one ray is approximately parallel to the longitudinal axis of the elongated handle, and the other ray is approximately perpendicular to said longitudinal axis of the elongated handle, thus form a 90-degree, or right angle as shown in the attached figures. This embodiment of the present disclosure thus has foldability of at least one striking surface, to provide ease for storage.

In a preferred embodiment, one of the strike surfaces of the tool head contains tapered edges. The tapered edges begin to narrow until they reach a point, known as a break contact surface. This break contact portion contains a narrowed point which is similar to a slot-head. This contact surface is useful for chipping away at buildup of solid mass such as an ice ball, while maintaining control and safety. As earlier discussed, it is important to use finesse when using tools in sensitive areas, such as near the frog of a horse's hoof. Further, this first position of the break contact in some embodiments may have a slight or generally downward slope in relation to the linear axis of the top of the tool head. In such an embodiment, a user is able to acquire greater leverage, precision, and accuracy with their use of the ice removal tool.

A hoof pick is provided in one embodiment which may be attached, formed, affixed, or otherwise integral with the second end of the elongated handle located at an opposing end of the elongated handle away from that of the tool head. The hoof pick is thought to contain an exterior edge along the outside of the hoof pick itself, an upper edge, which is also known as the curved upper portion of the hoof pick, and a contact surface, which is the general end point of the pick itself. The hoof pick allows a user to apply precision removal of small debris particles in a horse hoof or other crevice as previously-discussed.

It is specifically contemplated that any number of styles of hoof picks may be used and depending on the particular circumstances of the horse hoof or hooves, and the user's preference, each would have its own advantages and disadvantages. It is presently thought that a hoof pick made of a highly durable material such as steel might be useful as the pick, and multiple shapes are contemplated herein, whether the general shape is triangular, cylindrical, or otherwise, the hoof pick can help to scrape and remove small stones, or debris that is lodged in a hoof. To assist in the overall task, an additional brush may be affixed or attached to the exterior of the horse pick so as to brush away any dirt or debris loosened but still present in the hoof.

It is presently contemplated that in certain embodiments the hoof pick at the second end of the elongated handle may be foldable along a 180-degree radius, or an approximately 90-degree short radius from the second end of the elongated handle inwards. In such a fashion the hoof pick is able to be extended from an extended position positioned outwards from the elongated handle and is also able to rotate in towards the elongated handle itself by way of a hinge to provide foldability as depicted in the attached figures. In such a manner the hoof pick may rest against the elongated handle itself while not in use.

A hoof knife may be provided in some embodiments. The hoof knife is known and described herein as a blade element where the tip of the knife's blade is turned back on itself similar to a shepherd's crook shape. This hoof knife can serve a variety of purposes, such as trimming a horse's frog, cleaning up exfoliation on the sole, or for general sculpting, prying, and loosening of debris. An embodiment disclosed herein depicts the just-described hoof knife at a position on or near the second end of the elongated handle. The hoof knife may also have the above-described foldability as one embodiment of the hoof pick, by rotating outwards and inwards in relation to the elongated handle itself by way of a hinge. It is also contemplated that the hoof knife might be on the second striking surface of the tool head. In so doing, the hoof knife is positioned on the generally linear axis of the upper tool head as opposed to on or near the second end of the elongated handle.

In a contemplated embodiment, ice removal tool additionally comprises an attachment device so as to assist in storing the ice removal tool. Said attachment device may be a D-ring, a D-Loop, an O-ring or O-Loop, an Oval ring, or Oval Loop, or any other ring or loop to assist in hanging on a nail, for example. Further examples of attachment devices may be a form of a shackle or a gate, or even a carabiner. These attachment devices are provided for ease of storage and may be put, by way of example, on a user's belt or upon or in a saddle such that the present invention is readily available even when not in use at a particular moment. As an alternative to being located on or near the hoof pick exterior, it is also contemplated that this attachment device may be located at any other position upon the ice removal tool as is most practical, such as at a position on the upper surface of the substantially linear central body, or upon the exterior of a hoof pick or hoof knife near the second end of the elongated handle.

Various other features, advantages, and objects of the present invention will be made apparent from the following detailed description and any appended drawings herein.

### BRIEF DESCRIPTION OF THE FIGURES

One or more preferred exemplary embodiments of the invention are illustrated in the accompanying drawings in which like reference numerals represent like parts throughout and in which:

FIG. 1 is a perspective view of the Ice Removal Tool in accordance with some embodiments of the present disclosure, including an elongate handle element and first and second striking members, also including a hoof pick.

FIG. 2 is a partial perspective view of the Ice Removal Tool in accordance with some embodiments of the present disclosure highlighting an embodiment of the first striking surface.

FIG. 3 is a partial perspective view of the Ice Removal Tool in accordance with some embodiments of the present disclosure highlighting an embodiment of the tool head.

FIG. 4 is a partial perspective view of an embodiment of the Ice Removal Tool highlighting an embodiment of the tool head.

FIG. 5 is a perspective view of the Ice Removal Tool in accordance with some embodiments of the present disclosure, including a hoof knife at the end of the elongate handle element.

FIG. 6 is a perspective view of the Ice Removal Tool in accordance with some embodiments of the present disclosure, wherein a brush is included on the exterior of a hoof pick, and a hoof knife is utilized as the second striking surface of the tool head.

FIG. 7 is a perspective view of the Ice Removal Tool in accordance with some embodiments of the present disclosure, highlighting the foldability features of one embodiment of the present disclosure by way of the presence of multiple hinges.

FIG. 8 is a perspective view of the Ice Removal Tool in accordance with some embodiments of the present disclosure, illustrating an ergonomic handle.

Before explaining one or more embodiments of the invention in detail, it is to be understood that the invention is not limited in its application to the details of construction and the arrangement of the components as set forth in the following description or as illustrated in any appended drawings. The invention is capable of other embodiments and appearances, and may be practiced or carried out in various ways. Also, it is to be understood that the phraseology and terminology employed herein is for the purpose of description and should not be regarded as limiting.

### DESCRIPTION OF THE INVENTION

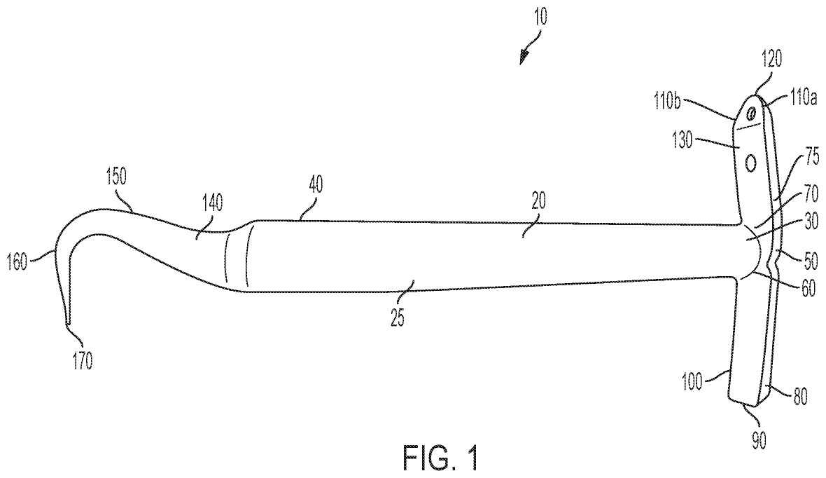

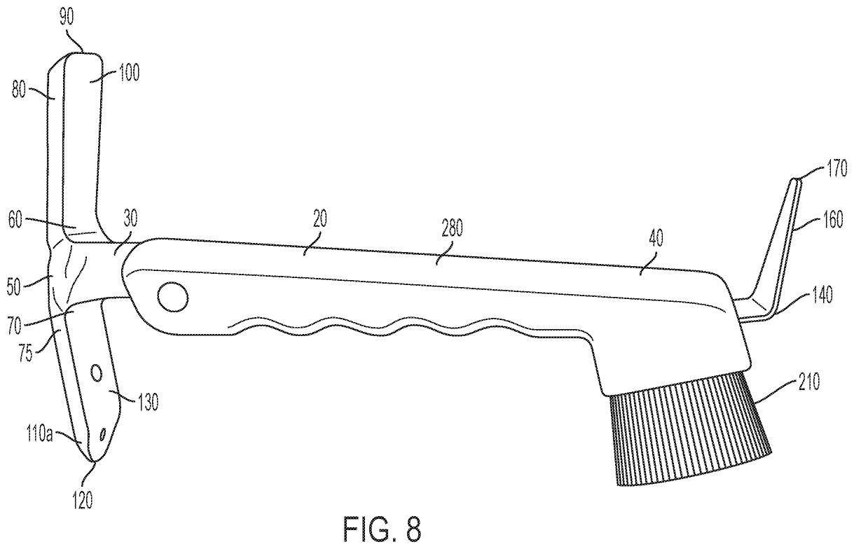

Referring to FIG. 1, an ice removal tool 10 is shown according to some embodiments of the present disclosure. The ice removal tool 10 includes a generally cylindrical elongated handle 20 with a first end 30 and a second end 40. The elongated handle 20 as shown is generally cylindrical, and may additionally have an ergonomic wrapping 280 (as shown in FIG. 8) around the elongated handle circumference 25. Integral with the first end 30 is a substantially linear central body 50 having a first striking surface 130 and a second striking surface 100. The location nearest the elongated handle first end 30 and the first striking surface 130 is known as the first connection point 70, and the location nearest the elongated handle first end 30 and the second striking surface 100 is known as the second connection point 60.

The substantially linear central body 50 may additionally contain a downward slope 75 near the first striking surface 130. This downward slope 75 is known to be relative to the perpendicular nature of the substantially linear central body 50 with the axis created from the elongated handle 20 of the present disclosure. Further, the first striking surface 130 may contained tapered edges 110a, 110b, which generally converge away from the substantially linear central body 50 and towards a first contact surface 120.

The second striking surface 100 in the present figure is shown here to have a beveled edge 80, which allows for the ability of a human user to scrape or pry with said implement. The beveled edge 80 meets at a second contact surface 90.

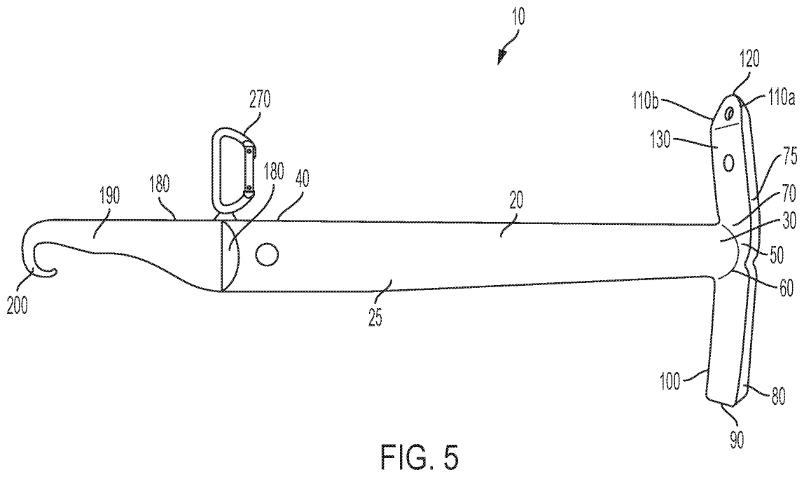

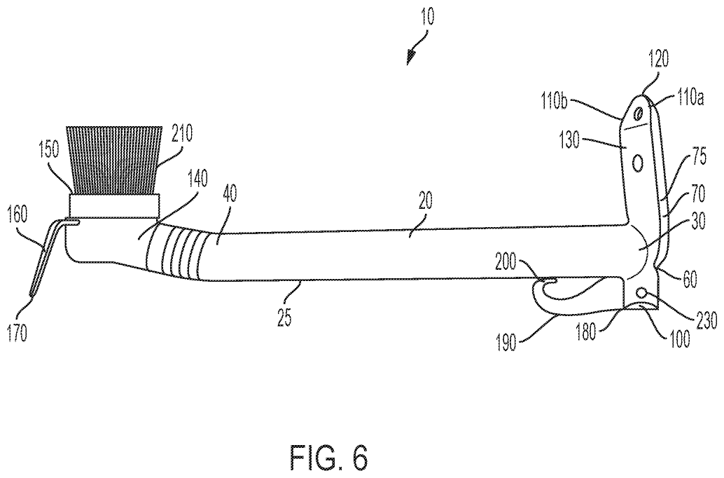

The elongated handle second end 40, which is located opposite that of the elongated handle first end 30 in this embodiment utilizes a hoof pick 140. The hoof pick 140 contains an exterior edge 150 with ability for additional features (such as shown in FIGS. 5-6). Additionally, the hoof pick 140 has an upper edge 160, and a contact surface 170.

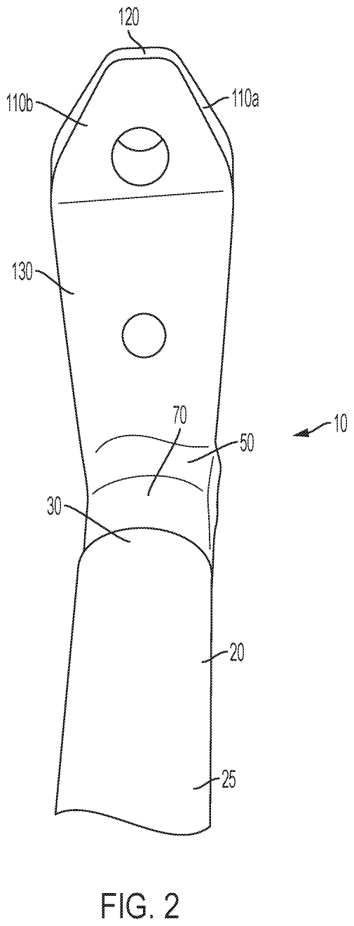

Turning now to FIG. 2, the ice removal tool 10 is shown with a partial perspective view, from the underside of a first striking surface 130. The first connection point 70 is highlighted, where the substantially linear central body 50 abuts, or touches, the elongated handle 20. As is clear in this figure, the tapered edges 110a, 110b converge towards the first contact surface 120 of the tool head.

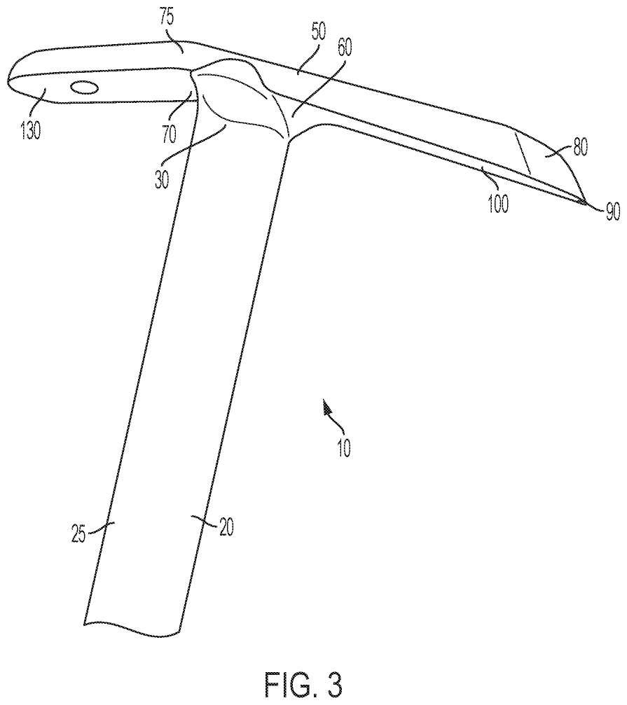

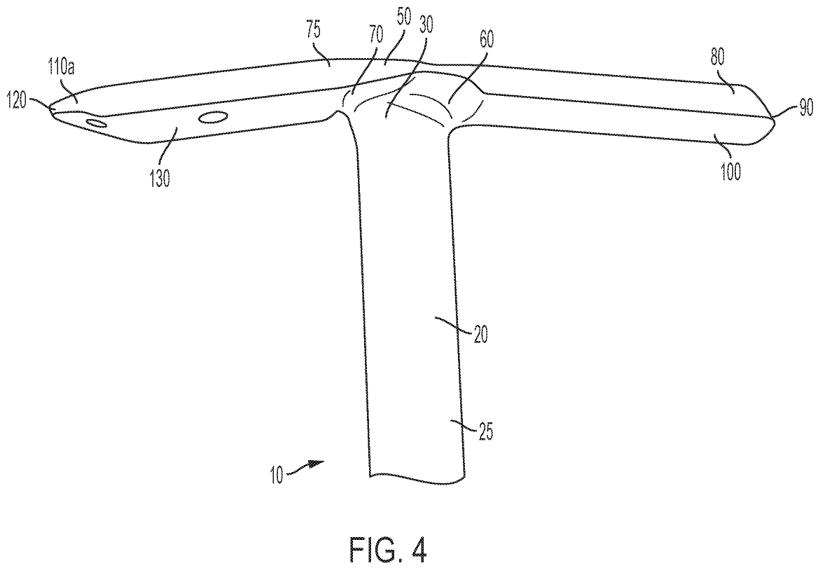

In FIGS. 3-4, the ice removal tool 10 is shown with partial perspective views, and may be used as a juxtaposition of the substantially linear central body 50 as it relates to an embodiment such as in FIG. 3 wherein a first striking surface downward slope 75 is utilized, opposed to the embodiment disclosed in FIG. 4 wherein no downward slope 75 is present.

Looking at FIG. 3, the second striking surface 100 highlights the beveled edge 80. The second contact surface 90 is the end of the substantially linear central body 50 on the second distal end. Opposing this distal end is the first distal end shown in FIG. 4, where a first contact surface 120 is present.

As shown in FIG. 5, the adaptability of the ice removal tool 10 is highlighted, where a hoof knife 180 is located at a position near the elongated handle second end 40. The embodiment as shown is similar to that disclosed in FIG. 1, with the replacement of a hoof knife 180 for the presence of a hoof pick 140. The hoof knife 180 features an exterior edge 190, and a curved tip similar to a shepherd's crook 200. The elongated handle 20 as shown herein is generally cylindrical, and may additionally comprise an ergonomic handle 280 (as shown in FIG. 8) around the elongated handle circumference 25.

Further, it is shown in this FIG. 5 that a carabiner 270 is affixed at a location near the hoof pick exterior edge 190, for ease of storage. This carabiner 270 is shown by way of example, and as disclosed previously, may be an alternative storage device such as a ring, a loop, or other device. It is also contemplated that the carabiner 270, or similar storage device, may be affixed or attached at a different location such as on the upper surface of the substantially linear central body 50.

Turning now to FIG. 6, an embodiment of the present invention has a variety of alternative farrier uses, and thus may feature a variety of implements formed or connected to the first striking surface 130 or the second striking surface 100, as shown here in this figure. As discussed earlier, in this image a hoof knife 180 is present at the location of the second striking surface 100, while the aforementioned hoof pick 140 is at the located at a position near the elongated handle second end 40. The hoof knife 180 contains an exterior edge 190 and a shepherd's crook tip 200. The first striking surface 130 contains tapered edges 110a, 110b, converging towards a first contact surface 120 on the distal end as opposed to the hook knife 180. In this embodiment the hoof pick 140 as shown here utilizes the additional feature of a brush 210 located on the hoof pick exterior surface 150 so as to allow for the sweeping out of debris from a hoof or crevice.

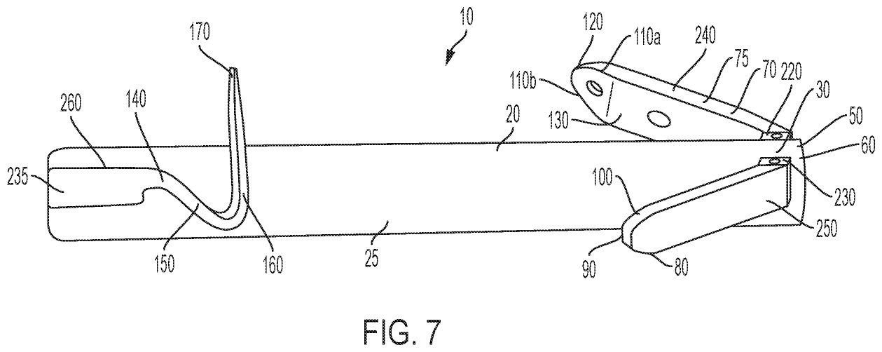

FIG. 7 highlights the ability of one embodiment of the present disclosure to allow for the foldability of one or more of the ends of the ice removal tool 10. In this figure, the previously mentioned first connection point 70 and the second connection point 60 are the location of a hinge or bearing or bore or the like, which turns the said connection points into a first hinge 220 and a second hinge 230 respectively. The first hinge 220 allows for the 90-degree movement of the first striking surface 130 from an opened position as shown in FIGS. 1-6, into the first striking surface closed position 240 as shown here. Similarly, the second hinge 230 allows for the second striking surface 100 to move into the second striking surface closed position 250 as depicted in the present figure. Further, in this image the ability of the hoof pick 140 to rotate from an extended position by way of a third hinge 235 to this second end closed position 260 is shown. In so doing, should all three instruments of the ice removal tool 10 be folded to their respective closed positions, the ice removal tool 10 itself will be a compact device, which may fit in a hammer loop of a tool belt, a pouch of a horse saddle, or possibly even in a human user's pants pocket.

Now viewing FIG. 8, it is shown the ergonomic handle 280 as may be utilized in some embodiments of the ice removal tool 10. As is now clear, the ergonomic handle substantially covers the entirety of the ergonomic handle circumference 25. The elongated handle 20 as shown has a substantially linear central body 50 comprising a first striking surface 130 and a second striking surface 100, all together collectively known as the tool head, connected to the elongated handle first end 30. On the opposing end of the elongated handle 20 is the elongated handle second end 40, which additionally comprises a hoof pick 140. On the hoof pick exterior edge 150 is a brush 210. As is noticeable here, the first striking surface 130 comprises tapered edges 110a, 110b, that disperse, or widen out, towards the substantially linear central body. In such a fashion, the first striking surface 130 contains a slot-head first contact surface 120, with a generally downward slope as relative to the tool head itself. This results in a mild scoop formation on this embodiment of the first striking surface 130, as contrasted from the generally linear axis of the second striking surface 100.

Understandably, the present invention has been described above in terms of one or more preferred embodiments and methods. It is recognized that various alternatives and modifications may be made to these embodiments and methods that are within the scope of the present invention. It is also to be understood that, although the foregoing description and drawings describe and illustrate in detail one or more preferred embodiments of the present invention, to those skilled in the art of hand tools, hand tool accessories, ice and debris removal, or in any other art to which the present invention relates, the present disclosure will suggest many modifications and constructions, as well as widely differing embodiments, applications and methods without thereby departing from the spirit and scope of the invention.

What is claimed is:

1. An ice removal tool comprising:
an elongated handle having a first end and a second end, said elongated handle adapted to be removably received by a human user;
a tool head with a substantially linear central body having a first distal end and a second distal end, said tool head connected to the first end of said elongated handle;
a hoof pick having a contact surface, an exterior edge, and an upper edge, said hoof pick being connected to the second end of said elongated handle; and
wherein said tool head further includes a striking surface at the first distal end thereon.

2. The ice removal tool of claim 1 wherein the striking surface additionally comprises a plurality of tapered edges that disperse towards the substantially linear central body of the tool head.

3. The ice removal tool of claim 1 wherein said tool head additionally includes a second striking surface on the substantially linear central body of the tool head at the second distal end thereon.

4. The ice removal tool of claim 3, wherein the exterior edge of the hoof pick additionally comprises a brush.

5. The ice removal tool of claim 4, wherein the elongated handle additionally comprises an ergonomic handle.

6. The ice removal tool of claim 3, wherein the second striking surface additionally comprises a hoof knife.

7. An ice removal tool comprising:
a tool head including a first strike surface and a second strike surface, and a substantially linear central body space being defined between the first strike surface and the second strike surface, said central body space extending along a generally linear axis;
an elongated handle having a top end and a bottom end, said top end attached to the central body space of the tool head;
a hoof knife, having an exterior edge and a shepherd's crook tip, said hoof knife attached to the bottom end of the elongated handle; and
wherein the elongated handle is a generally cylindrical shape.

8. The ice removal tool of claim 7, wherein the central body space of the tool head at the first strike portion contains a generally downward slope relative to the linear axis of the second strike portion.

9. The ice removal tool of claim 8, wherein the central body space of the tool head additionally comprises tapered edges that converge towards the first strike portion.

10. The ice removal tool of claim 9, wherein the hoof knife exterior edge additionally comprises a brush.

11. The ice removal tool of claim 10, wherein the elongated handle additionally comprises an ergonomic handle.

12. The ice removal tool of claim 11, wherein the second strike portion additionally comprises a beveled edge.

13. The ice removal tool of claim 12, wherein the hoof pick additionally comprises one of: ring, loop, shackle, gate, and carabiner.

14. The ice removal tool of claim 12, wherein the central body space of the tool head additionally comprises one of: ring, loop, shackle, gate, and carabiner.

15. A foldable ice removal tool comprising:
an elongated handle having a top end and a bottom end;
a tool head with a substantially linear central body having a first end and a second end, the first end pivotably connected to the top end of the elongated handle at a first hinge, and the second end pivotably connected to the top end of said elongated handle at a second hinge;
wherein said tool head further includes a first strike surface and a second strike surface disposed generally at opposite positions on the first end and the second end of said tool head substantially linear central body; and
wherein an instrument is pivotably connected with the bottom end of the elongated handle at a third hinge.

16. The foldable ice removal tool of claim 15, wherein the instrument further comprises a hoof knife having an exterior edge and a shepherd's crook tip.

17. The foldable ice removal tool of claim 15, wherein the instrument further comprises a hoof pick.

18. The ice removal tool of claim 17, wherein the hoof pick exterior edge additionally comprises a brush.

19. The ice removal tool of claim 18, wherein the elongated central body additionally comprises tapered edges that converge towards the front strike surface.

20. The ice removal tool of claim 19, wherein the second strike surface additionally comprises a beveled edge.
